(19) United States
(12) Patent Application Publication
(10) Pub. No.: US 2014/0304028 A1
(43) Pub. Date: Oct. 9, 2014

(54) EXECUTION OF FLOW DIAGRAMS

(71) Applicant: Avaya Inc., Basking Ridge, NJ (US)

(72) Inventors: Vishal Saxena, Palo Alto, CA (US); Anurag Aggarwal, Ghaziabad (IN)

(73) Assignee: Avaya Inc., Basking Ridge, NJ (US)

(21) Appl. No.: 14/245,838

(22) Filed: Apr. 4, 2014

Related U.S. Application Data
(60) Provisional application No. 61/808,303, filed on Apr. 4, 2013.
(60) Provisional application No. 61/808,633, filed on Apr. 5, 2013.

(51) Int. Cl. G06Q 10/06

(52) U.S. Cl. CPC G06Q 10/0633
USPC 705/7.27

(57) ABSTRACT

In some embodiments, a method comprises processing parameters at a current node of a plurality of nodes in a process flow diagram. The method may further, in some embodiments, comprise receiving a signal at the current node from a first immediate preceding node of the plurality of nodes. The first immediate preceding node may be connected to the current node, in some embodiments. In some embodiments, the method may include: determining whether the current node is connected to a second immediate preceding node of the plurality of nodes in the process flow diagram, and in response to determining the current node is connected to the second immediate preceding node, determining whether to process parameters associated with the current node in absence of receipt of a signal from the second immediate preceding node or to wait to receive the signal from the second immediate preceding node prior to processing the parameters.

### RELATED APPLICATIONS

This application claims the benefit of and priority to the U.S. provisional patent application No. 61/808,303, filed on Apr. 4, 2013, by Saxena et al. and U.S. provisional patent application No. 61/808,633, filed on Apr. 5, 2013, by Saxena et al., the disclosures of which are incorporated herein in their entirety and for all purposes.

### BACKGROUND

In general, businesses may employ flow diagrams, e.g., business process diagram (BPD), to define a sequence of procedural steps to be performed to ensure smooth operation of business activities. For example, a business may employ a BPD that defines a home loan approval process, an insurance claim approval process, purchase order fulfillment process, and the like. Typically, businesses may implement these flow diagrams using standard business method modeling languages, such as, Business Process Model and Notation (BPMN) and Business Process Execution Language (BPEL), to graphically illustrate steps and activities of a business method.

Unfortunately, conventional business method modeling languages may have limitations in real-world business applications, e.g., execution of one or more procedures out of sequence, bypassing certain activities, dynamically invoking and performing certain procedures, etc. These limitations are partly due to defining the process relationships in a static fashion at design time, e.g., process dependencies, statically defining the sequence of activities at design time, etc.

### SUMMARY

Accordingly, a need has arisen to facilitate modification to the execution sequence of a process, e.g., in a business process diagram (BPD), in a dynamic fashion. For instance, the execution of a BPD may be modified based on presence or absence of an activation signal at a specific processing node/gateway node (process) in the BPD, injection of an activation signal and/or a deactivation signal at a node, presence or absence of a deactivation signal at a node, etc. It is appreciated that processing nodes and gateway nodes may be referred to as a node throughout this application. Furthermore, it is appreciated that a signal, e.g., activation signal, deactivation signal, etc., may be a token, a message, a command, an indication, etc. It will become apparent to those skilled in the art after reading the detailed description that the embodiments described herein satisfy the above mentioned need.

According to various embodiments, systems and methods described herein provide a mechanism to dynamically modify the execution of a process, e.g., BPD, based on run-time activation and/or deactivation of a node, presence or absence of an activation signal and/or deactivation signal at a node, etc. In some embodiments, a process may include a plurality of nodes representing a sequence of steps and procedures in a flow, e.g., in a business method. For example, a node (e.g., the current node) of a BPD may be expecting two inputs from two immediately preceding nodes in the BPD (e.g., a first preceding node and a second preceding node). In such a scenario, when the current node receives a signal from the first preceding node, a determination is made whether to wait to receive a signal from the second preceding node prior to processing parameters at the current node, or to alternatively, process parameters associated with the current node in absence of receipt of a signal from the second preceding node.

In some embodiments, this determination whether to wait or whether to proceed with the processing may be made by performing a reverse traversal of the BPD. Traversing the BPD can be used to determine whether an activation signal can ever be received at the current node from the second preceding node or any other node preceding the second preceding node. That is, the BPD is traversed from the current node to the second preceding node and other nodes preceding the second preceding node to determine whether any of the preceding nodes is operable to generate an activation signal. The current node waits to receive an active signal from the preceding nodes before processing parameters at the current node if it is determined that the identified preceding node may generate an active signal for the current node. On the other hand, the current node may proceed with parameter processing if it is determined that the identified preceding node will not generate an activate signal for the current node. Accordingly, the processing at a given node is delayed only when needed and proceeds when it is not necessary to wait.

In some embodiments, new parameters may become available that were previously not available for a given node. Accordingly, it is desirable to re-execute the process for the node at which the new parameters become available. In some embodiments, an activate signal may be injected at a node of the BPD to invoke the execution of a node and succeeding nodes to process the newly available parameters. As such, the execution a BPD may be modified dynamically at runtime to appropriately account for changes in the BPD, e.g., changes in chronology of processing steps, availability of new parameters, etc.

In some embodiments, a method may comprise processing parameters at a current node of a plurality of nodes in a process flow diagram and receiving a signal at the current node from a first immediate preceding node of the plurality of nodes. In some embodiments, the first immediate preceding node may be connected to the current node. The method may further comprise determining whether the current node is connected to a second immediate preceding node of the plurality of nodes in the process flow diagram, and in response to determining that the current node is connected to the second immediate preceding node, determining whether to process parameters associated with the current node in absence of receipt of a signal from the second immediate preceding node or to wait to receive the signal from the second immediate preceding node prior to processing the parameters.

In some embodiments, the process flow diagram may be unstructured, and the unstructured process flow diagram may include a dependency between two branches within the process flow diagram. In some embodiments, the method may further include receiving the signal from the second immediate preceding node within a predetermined wait time period, and responsive to receiving the signal from the second immediate preceding node, processing the parameters associated with the current node. Then, the method may further include transmitting a signal from the current node to an immediate succeeding node of the plurality of nodes. In some embodiments, the transmitted signal from the current node may be an activation signal or a deactivation signal.

In some embodiments, the method may further include processing the parameters associated with the current node in response to a wait time exceeding a wait time period and further in absence of receiving the signal from the second immediate preceding node, and transmitting a signal from the current node to an immediate succeeding node of the plurality of nodes. In some embodiments, the transmitted signal from the current node may be an activation signal or a deactivation signal.

The method may further comprise, in some embodiments, in response to determining that the current node is connected to the second immediate preceding node and further in response to absence of receipt of the signal from the second immediate preceding node, traversing from the current node to the second immediate preceding node and further to nodes preceding the second immediate preceding node and connected thereto to identify a live node. In some embodiments, the method may further comprise waiting to receive a signal at the current node from the identified live node in response to determining that the identified live node is operable to generate an activation signal for the current node.

The method of may further include, in some embodiments, responsive to determining that the identified live node is inoperable to generate an activation signal for the current node, processing the parameters associated with the current node in absence of receiving the signal from the second immediate preceding node. In some embodiments, the method may also include receiving an activation signal being injected at a node preceding the current node, and re-processing parameters associated with the node preceding the current node being injected with the activation signal. In some embodiments, the node preceding the current node being injected with the activation signal may previously generated a deactivation signal.

In some embodiments, the method may further include processing parameters associated with the current node prior to the activation signal being injected to the node preceding the current node and transmitting a signal from the current node to an immediate succeeding node of the plurality of nodes. The transmitted signal from the current node may be an activation signal or a deactivation signal, in some embodiments. In some embodiments, the method may further include re-processing the parameters associated with the current node in response to the injection of the activation signal to the node preceding the current node and further in response to the re-processing generating an activation signal.

In some embodiments, the method may further include receiving signals at the current node from every immediate preceding node of the plurality of nodes connected to the current node, and in response to the activation signal being injected, waiting at the current node to receive an updated signal from the node preceding the current node being injected with the activation signal and further waiting at the current node to receive updated signals from nodes that connect the node being injected and the current node, and processing parameters associated with the current node in response to receiving the updated signals.

In some embodiments, a non-transitory computer-readable storage medium having stored thereon, computer executable instructions that, if executed by a processor causes the processor to perform a method comprising executing processes associated with a current node of a plurality of nodes of a process flow diagram and receiving an activation signal being injected at a node preceding the current node. The node preceding the current node being injected with the activation signal may previously generated a deactivation signal. In some embodiments, the method may further include responsive to receiving the activation signal being injected, executing processes associated with the node preceding the current node.

In some embodiments, the method may further include re-executing processes associated with the current node in response to the injection of the activation signal to the node preceding the current node and further in response to receiving an updated signal from nodes that connected the node being injected and the current node. The method may further include, in some embodiments, before the activation signal being injected, receiving signals at the current node from every immediate preceding node of the plurality of nodes connected to the current node, and in response to receiving signals at the current node from every immediate preceding node, traversing from the current node to nodes preceding the particular node to identify whether a node preceding the current node has been injected with the activation signal, and in response to determining that the node preceding the current node has been injected with the activation signal, determining whether to wait for updated signals to be received by the current node.

In some embodiments, the method may include in response to determining to wait for updated signals to be received by the current node and in response to receiving the updated signals, re-processing at the current node based on the updated signals. The method may further include waiting for the updated signals for a predetermined wait period, in some embodiments.

In some embodiments, a method may comprise receiving a signal at a current node of a plurality of nodes of a process flow diagram from a first immediate preceding node. The signal may be an activation signal or a deactivation signal. The method may further include in response to receiving the signal, determining whether the current node is connected to a second immediate preceding node of the plurality of nodes, and in response to determining that the current node is connected to the second immediate preceding node and in absence of receipt of a signal from the second immediate node, traversing from the current node to the second immediate preceding node and further to nodes preceding the second immediate preceding node connected thereto to identify a live node, and then determining whether the live node is operable to generate an activation signal for the current node.

In some embodiments, the method may include waiting to receive a signal at the current node from the identified live node in response to determining that the identified live node is operable to generate an activation signal for the current node. The method may further include, in some embodiments, responsive to determining that the live node is inoperable to generate an activation signal for the current node, executing processes associated with the current node in absence of receiving the signal from the second immediate preceding node. In some embodiments, the method may further include receiving an activation signal being injected at a node preceding the current node, and responsive to receiving the activation signal, executing processes associated with the node preceding the current node being injected with the activation signal. The node preceding the current node being injected with the activation signal may previously generated a deactivation signal.

In some embodiments, the method may further include receiving signals at the current node from every immediate preceding node of the plurality of nodes connected to the current node, and in response to the activation signal being injected, waiting at the current node to receive an updated signal from the node preceding the current node being injected with the activation signal and further waiting at the current node to receive updated signals from nodes that connect the node being injected and the current node, and executing processes associated with the current node in response to receiving the updated signals.

These and other features and aspects of the embodiments may be better understood with reference to the following drawings, description, and appended claims.

### BRIEF DESCRIPTION OF DRAWINGS

FIGS. 1A-1C show execution of an exemplary structured process flow diagram in accordance with some embodiments.

FIGS. 2A-2C show execution of an exemplary structured process flow diagram in accordance with some embodiments.

FIG. 3 show execution of an exemplary unstructured process flow diagram in accordance with one embodiment.

FIGS. 4A-4C show execution of an exemplary unstructured process flow diagram in accordance with some embodiments.

FIGS. 5A-5B show execution of an exemplary process flow diagram being dynamically modified in accordance with some embodiments.

FIGS. 6A-6C show execution of an exemplary process flow diagram being dynamically modified in accordance with some embodiments.

FIGS. 7A-7B show an exemplary method to execute a process flow diagram in accordance with an embodiment.

FIG. 8 shows an exemplary method to execute a process flow diagram being dynamically modified in accordance with an embodiment.

FIG. 9 shows a block diagram of an exemplary computer system in accordance with one embodiment.

### DETAILED DESCRIPTION

References will now be made in detail to various embodiments, examples of which are illustrated in the accompanying drawings. The embodiments described are for illustrative purposes only and it will be understood that these various embodiments are not intended to limit the scope. On the contrary, the embodiments are intended to cover alternatives, modifications, and equivalents, which may be included within the scope of the appended Claims. Furthermore, in the following detailed description of various embodiments, numerous specific details are set forth in order to provide a thorough understanding of the claims. However, it will be evident to one of ordinary skill in the art that the claims may be practiced without these specific details. In other instances, well known methods, procedures, components, and circuits have not been described in detail as not to unnecessarily obscure aspects of the embodiments.

Some sections of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “processing,” “re-processing,” “executing,” “re-executing,” “determining,” “identifying,” “waiting,” “transmitting,” “generating,” “propagating,” “providing,” “traversing,” “associating,” “injecting,” “initiating,” “invoking,” “updating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

Described herein are embodiments to execute a process and a flow, e.g., business process, loan application, purchase order approval process, new hire onboarding process, vacation approval, etc. The embodiments are described with respect to a business process throughout this application. It is appreciated that the description with respect to business process is exemplary and not intended to limit the scope of the embodiments.

A business process diagram (BPD) may be generated using various software programs where the user can graphically define various processing steps and their chronological order and their relationship in a business process, e.g., in a loan application, purchase order fulfillment process, software release process, employee evaluation process, etc. The BPD may include a plurality of processing nodes and/or a plurality of gateway nodes, where each processing node and/or gateway node may represent a step and where the plurality of processing nodes and/or the plurality of gateway nodes represent a sequence of processing steps and their relationship with respect to one another. It is appreciated that processing nodes and gateway nodes may be referred to as a node throughout this application. Unfortunately, the business process defined by a BPD may not correlate to the real world since the nodes, their relationship, their chronological ordering, etc., is defined at the time that the BPD is being designed and is therefore static. However, in reality, the business process may be executed in a different sequence due to the availability or lack of availability of parameters when certain nodes of a BPD are being executed, on the fly business decisions to skip or to re-process certain nodes, etc.

In an illustrative example, a BPD may include a plurality of nodes representing various stages associated with a home loan approval process. Each node may be associated with a different processing step, e.g., determination of whether an applicant has completed a home loan application, determination of the loan amount the applicant is qualified for, a determination of whether there was a property inspection, closing, etc.

In this example, the property inspection step may depend on the completion of the home loan application and a determination of the qualified loan amount. In one example, the home loan application step may be completed, but the determination of the qualified loan amount may be incomplete because of the unavailability of the applicant's income information, credit score, etc. In such a scenario, rather than delaying the home inspection until a qualified loan amount is determined, the embodiments described herein may change the processing sequence associated with the BPD and initiate the home inspection process prior to completion of the qualified loan amount determination. Further, at a later time when the applicant's credit score and income information becomes available, the embodiments may modify the execution sequence of the BPD to determine the home loan qualification amount and further re-execute other steps in the BPD that depend on home loan qualification amount. Accordingly, the embodiments flexibly and dynamically change the execution sequence of a BPD by determining whether to wait for additional parameters to be received or whether to process the already received parameters without waiting to receive the additional parameters.

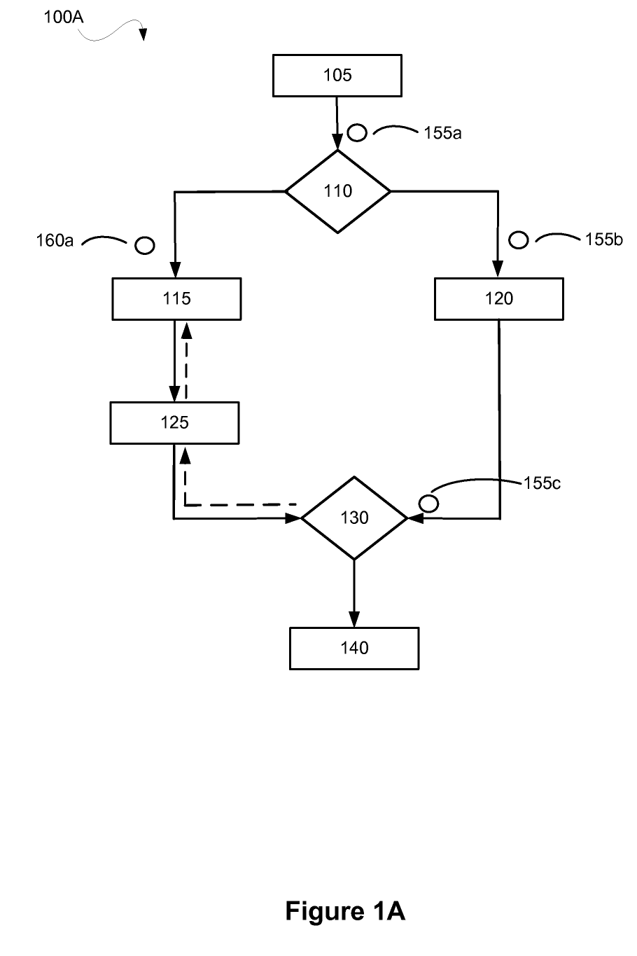

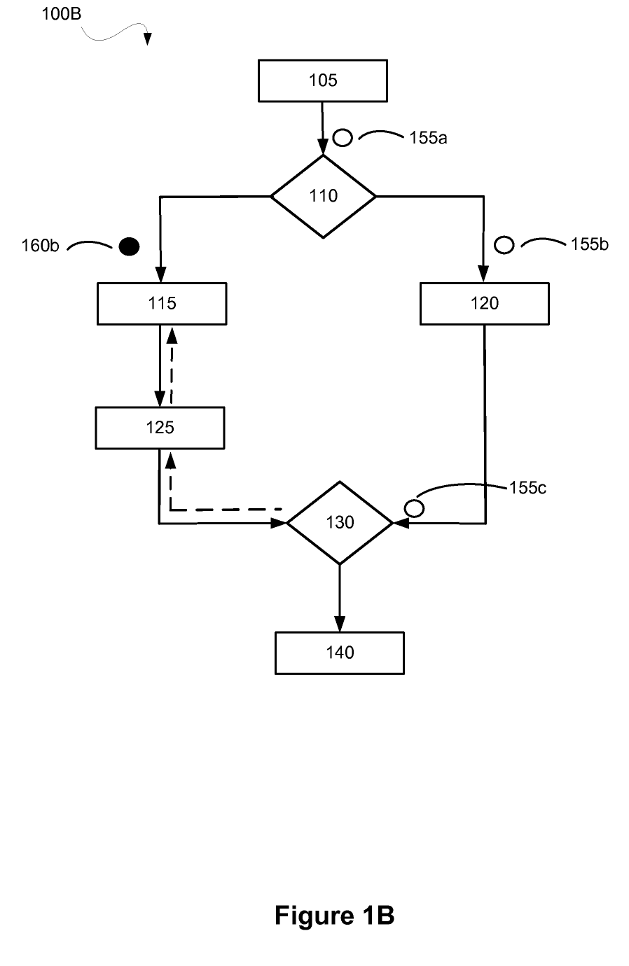

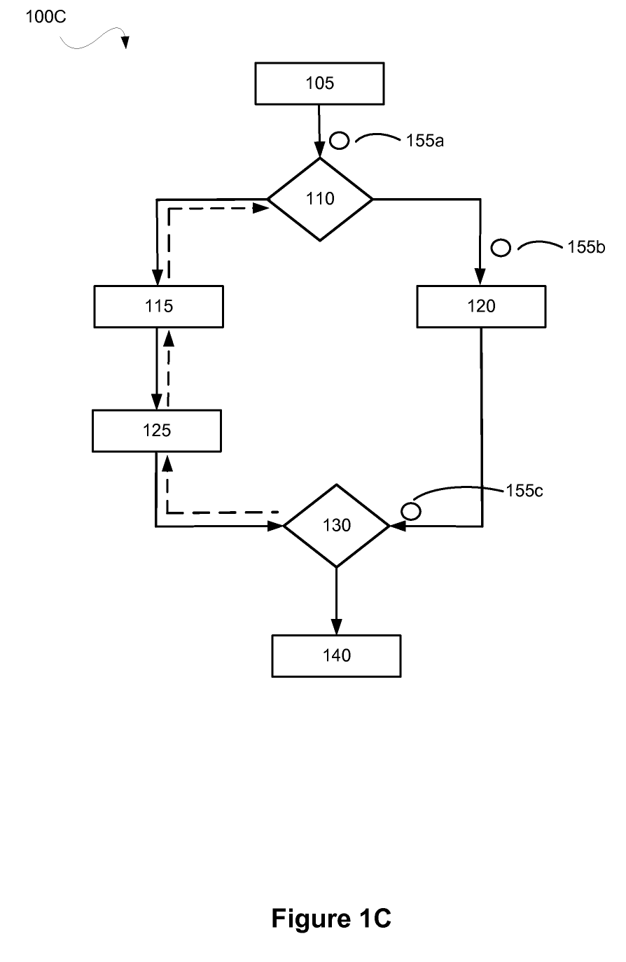

Referring now to FIG. 1A, execution of an exemplary structured process flow diagram is shown in accordance with one embodiment. According to one embodiment, the structured process flow diagram may be a business process diagram (BPD). It is appreciated that structured process flow diagram refers to flow processes where there is one input and one output, and further where there are no cross branch dependencies. In one embodiment, the BPD 100A has one input and one output and it includes two branches, e.g., left branch comprising nodes 115 and 125 and right branch comprising node 120. The two branches in BPD 100A have no cross dependencies. Accordingly, the BPD 100A is a structured BPD.

BPD 100A includes processing nodes 105, 115, 120, 125 and 140 and gateway nodes 110 and 130. Nodes may refer to processing nodes and/or gateway nodes throughout this application and as described herein may represent events, activities, processes and/or a combination of sub-processes in a process flow diagram. The gateways as described herein may represent a fork and/or junction in a process flow diagram that may be used to determine whether certain conditions are satisfied, whether parameters and/or inputs for follow on activities, events, etc. are available, and the like.

In this exemplary embodiment, the processing nodes may represent various steps during a loan process, e.g., processing node 105 may include gathering basic information about the applicant such as name, social security number, date of birth, etc. The gateway node 110 may be a decision whether the information provided by the applicant is sufficient or not, e.g., prior residential address of the applicant may not have been provided. In contrast, processing nodes 115, 120, and 125 may represent other steps during the loan process, e.g., property appraisal, applicant's credit score, inspection report, etc. It is appreciated that while this example is provided with respect to a loan process, the embodiments are not limited thereto. For example, the BPD may include a process flow diagram for answering a call at a call center, directing Internet traffic flow, directing vehicle traffic flow, etc.

In BPD 100A, activation signals and/or deactivation signals may be propagated downstream, e.g., from processing node 105 to gateway node 110 to processing node 120, etc. In some instances, the activation signal may be a signal configured to cause a node, e.g., a processing node or a gateway node, to process parameters and/or execute processes associated with that node. In some instances, the activation signal may indicate the availability of parameters for processing. For example, activation signal 155b may indicate to processing node 120 that the parameters associated with upstream processing nodes or gateway nodes, e.g., gateway node 110 or processing node 105, to be processed by processing node 120 are present. Similarly, activation signal 155c may indicate to gateway node 130 that parameters associated with the upstream processing nodes and upstream gateway nodes, e.g., processing nodes 120, 105 and gateway node 110, are present and can be processed by gateway node 130. In contrast, a deactivation signal (e.g., signal 160b in FIG. 1B) may indicate unavailability of parameters and/or inputs for processing. It is appreciated that a signal, e.g., activation signal, deactivation signal, etc., may be a token, a message, a command, an indication, etc.

In this exemplary embodiment, BPD 100A starts at processing node 105 by executing processes and/or process parameters associated with processing node 105. The activation signal 155a generated by processing node 105 is propagated to the gateway node 110. The gateway node 110 generates activation signal 155b, which is propagated to processing node 120. Processing node 120 processes parameters and generates activation signal 155c, which is propagated to the gateway node 130.

Gateway node 130 determines that it is also connected to another processing node and/or gateway node, e.g., processing node 125, from which it is waiting to receive a signal. In other words, the gateway node 130 is connected to a first immediate preceding processing node 120 and to a second immediate preceding processing node 125. It is appreciated that while the processing nodes 115 and 105 and the gateway node 110 are preceding nodes with respect to gateway node 130, they are not immediately preceding the gateway node 130 because they have intermediary nodes connected between them.

According to some embodiments, the gateway node 130 may determine whether to wait to receive a signal from its immediate preceding node, e.g., processing node 125, to process parameters or to process parameters without waiting any further to receive a signal from its immediate preceding node, e.g., processing node 125. It is appreciated that a processor may determine whether to wait to receive a signal or to proceed with processing based on heuristics. The heuristics may be based on various factors, e.g., threshold time lapse, possibility of receiving a signal from the immediate preceding node, number of inputs at the current node, etc.

In some embodiments, rather than waiting to receive a signal at a current node, e.g., a processing node or a gateway node such as gateway node 130, from an immediately preceding node, e.g., node 125, it is determined whether there is a possibility of receiving an activation signal from the preceding node(s), e.g., preceding processing node and/or gateway nodes such as nodes 125, 115, etc. The possibility of receiving an activation signal may be determined by reverse traversal of the nodes, e.g., the processing nodes and/or the gateway nodes (shown by dashed lines) preceding the current node which happens to be gateway node 130. That is, the BPD is traversed from a current node, e.g., gateway node 130, that is waiting to receive a signal, to other preceding nodes, e.g., processing nodes such as processing nodes 125, 115 and/or gateway nodes, in the BPD to identify a live node, e.g., node 115. A live node is a node, e.g., a processing node or a gateway node, that has received a signal, e.g., activation signal, deactivation signal, etc., from its preceding nodes and/or gateways, e.g., gateway 110, but has not generated a signal, e.g., activation signal, deactivation signal, etc., yet.

Once a live node is identified, it is determined whether there is a possibility that the identified live node can generate an activation signal. If it is determined that the live node could possibly generate an activation signal, then the current node, e.g., processing node or gateway node such as gateway 130, will wait, as shown in FIG. 1A, because processing node 115 has received an activation signal 160a. Otherwise, the current node e.g., gateway node 130, will execute processes and process parameters without waiting to receive a signal from its preceding nodes, e.g., processing node and/or gateway nodes such as processing node 125, that are connected to the live node, e.g., processing node 115, as shown in FIG. 1B, because processing node 115 has received a deactivation signal 160b. As noted above, the deactivation signal 160b may indicate to processing node 115 that parameters are unavailable to processing node 115 or that processing node 115 should not process any parameters, and thus, it is determined that there is no possibility that processing node 115 will generate an activation signal that may propagate to gateway node 130.

Traversal as illustrated by FIGS. 1A and 1B are exemplary and not intended to limit the scope of the embodiments. For example, any number of nodes, e.g., processing nodes and/or gateway nodes, may be traversed in order to identify a live node. For example, referring to FIG. 1C, after gateway node 130 receives activation signal 155c, BPD 100C is traversed from gateway node 130 to processing node 125, and further to processing node 115, and subsequently to gateway node 110 to identify the live node, e.g., live processing node or the live gateway, which is gateway node 110 in this example. In this example, since an active signal 155a is received by gateway node 110, it is determined that gateway node 110 may generate an active signal to be propagated through processing nodes 115 and 125. Accordingly, gateway node 130 may wait to receive a signal from processing node 125.

It is appreciated that wait time and execution time is reduced by traversing a process flow diagram because the node may proceed with its execution if it is determined that there is no possibility that a signal may be received from its preceding node. Further, the reverse traversal as described herein allows for dynamic changes in a process flow diagram, thereby better reflecting the real life scenario and allowing execution of a node to be skipped or performed without receiving all the signals from preceding nodes.

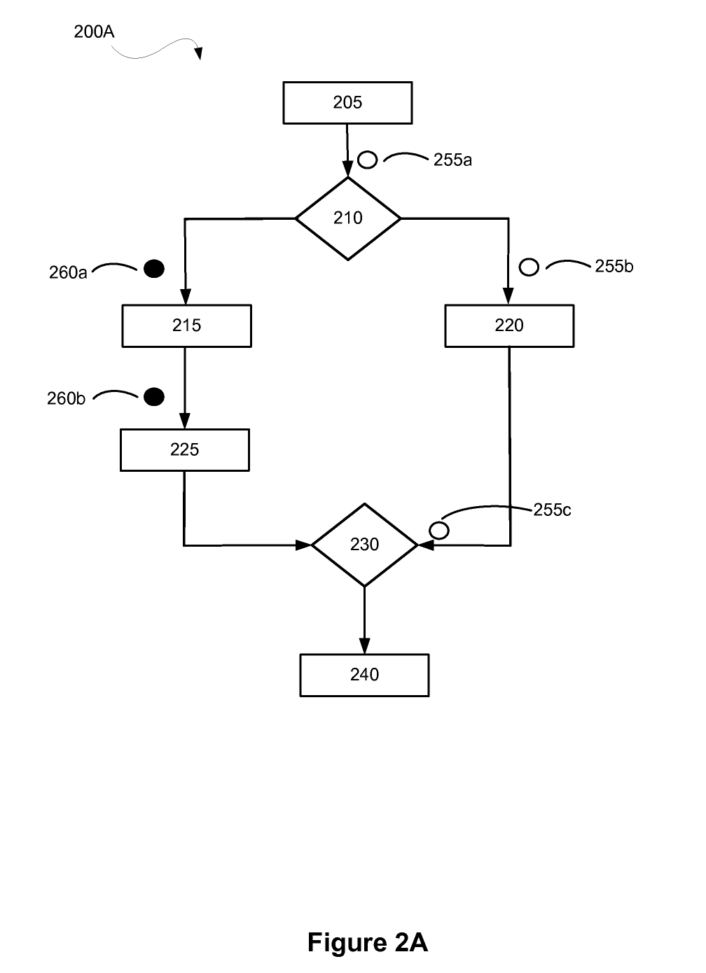

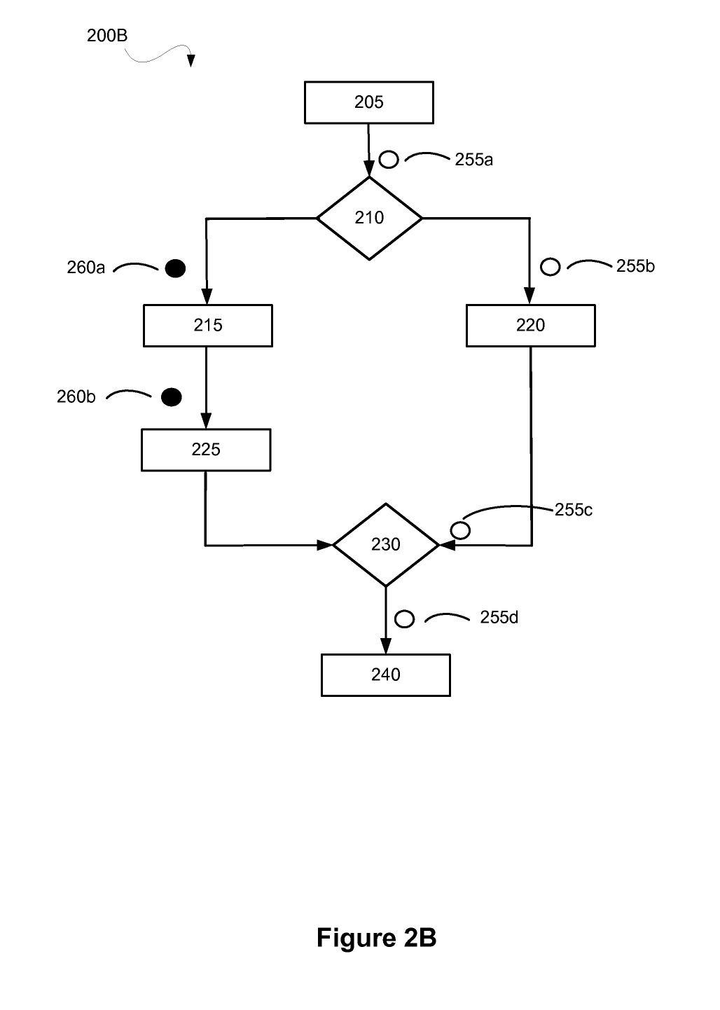

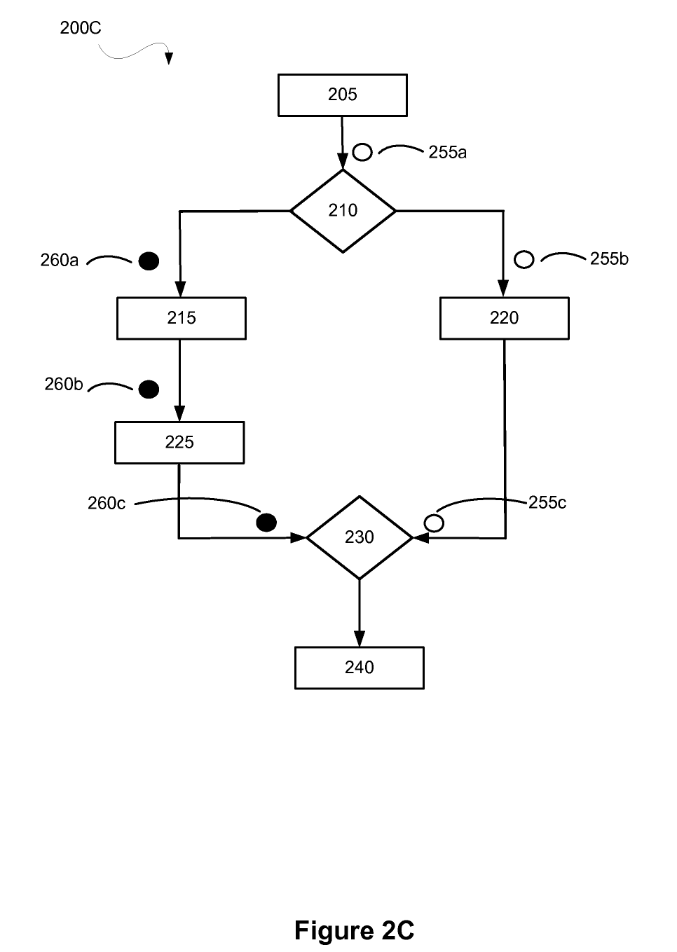

Referring now to FIG. 2A, execution of an exemplary structured process flow diagram is shown in accordance with some embodiments. Similar to FIGS. 1A-1C, FIG. 2A shows an exemplary structured BPD. BPD 200A includes a plurality of processing nodes 205, 215, 220, 225, and 240 corresponding to various processes. In this exemplary embodiment, the processing nodes may represent various steps during a loan process, a process flow diagram for answering a call at a call center, directing Internet traffic flow, directing vehicle traffic flow, etc., as discussed with respect to FIGS. 1A-1C.

FIG. 2A illustrates the execution state of BPD 200A at time T1. In this exemplary embodiment, activation signals 255a, 255b, and 255c are propagated downstream through the right branch. According to one embodiment, deactivation signals 260a and 260b are propagated downstream through the left branch.

It is appreciated that certain nodes of BPD 200A may take longer to process than other nodes or gateways. As such, there might be a delay in transmitting a signal, e.g., activation signal, deactivation signal, etc., from one node to the next. For instance, in one embodiment, processing nodes 215 and 225 may take longer to execute and process in comparison to processing node 220. It is further appreciated that these delays may cause the processing of the BPD 200A to hang. For example, gateway node 230 may wait indefinitely or for a long time to receive an activation signal or deactivation signal from processing node 225 in addition to the already received activation signal 255c.

Waiting for a long time or indefinitely, at gateway node 230, to receive a signal from processing nodes 215 and 225 may be unnecessary especially when the processing by processing nodes 215 and 225 have no impact on the processing by gateway node 230 and its outcome. According to some embodiments, the gateway node 230 may determine whether to wait to receive a signal from its immediate preceding node, e.g., processing node 225, to process parameters or to process parameters without waiting any further to receive a signal from its immediate preceding node, e.g., processing node 225. It is appreciated that a processor may determine whether to wait to receive a signal or to proceed with processing based on heuristics. The heuristics may be based on various factors, e.g., threshold time lapse, possibility of receiving a signal from the immediate preceding node, number of inputs at the current node, traversing upstream from the current node to preceding nodes, etc. For example, processing by processing nodes 215 and 225 may have no impact on processing by gateway node 230 if the processing nodes 215 and 225 generate a deactivation signal because gateway node 230 has received parameters that it should process from the processing node 220 and there are no parameters to be processed based on processing nodes 215 and 225. Further, processing by processing nodes 215 and 225 may have no impact on processing by gateway node 230 and its outcome if parameters passed by processing nodes 215 and 225 to the gateway node 130 are not to be used in its processing. As such, the gateway node 230 may wait for a long time or indefinitely if it has received the activation signal 255c from processing node 220 but has not received any signal from processing nodes 215 and 225.

With reference to FIG. 2B, embodiments described herein, reduce the wait time or indefinite waiting to receive a signal, e.g., activation signal, deactivation signal, etc., if a signal is not received within a given wait period. For example, gateway node 230 proceeds with processing despite the absence of receiving a signal from processing node 225 within a given wait period. As such, in this exemplary embodiment, BPD 200B proceeds to execute processes and parameters associated with gateway node 230 in absence of a receipt of a signal from processing node 225. The processing by gateway node 230 may result in an activation signal 255d that is subsequently transmitted to processing node 240. As such, long wait periods are reduced and processing hang up is eliminated.

Referring now to FIG. 2C, gateway node 230 receives deactivation signal 260c from processing node 220 within a predetermined wait period. As such, the BPD 200C proceeds to execute processes associated with gateway node 230.

Accordingly, by waiting for a given wait period (may or may not be predetermined), the creation of bottlenecks and/or a process hang at a node may be prevented. Further, by waiting for a predetermined wait period rather than for an indefinite period, the BPD may better express real-world business processes in which steps and activities are performed with the best available information at a given moment in time.

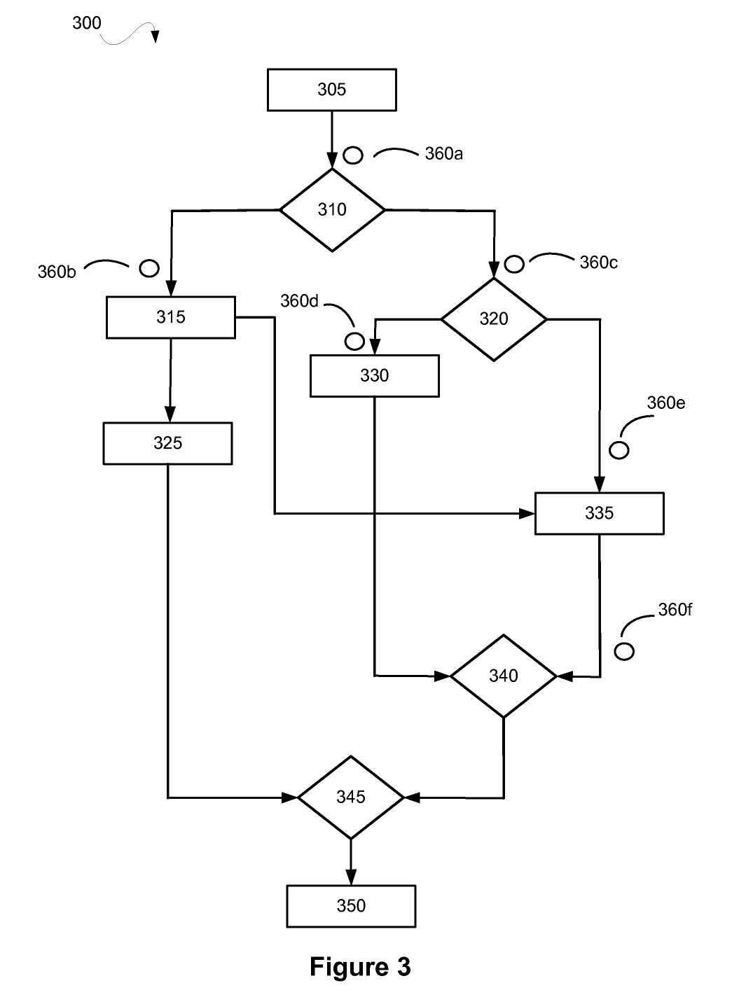

Referring now to FIG. 3, an execution of an unstructured BPD is shown in accordance with one embodiment. The process flow diagram illustrated is unstructured since there is a dependency between branches, e.g., dependency of processing node 335 in one branch to processing node 315 in another branch.

In this exemplary embodiment, BPD 300 includes processing nodes 305, 315, 325, 330, 335 and 350 and gateway nodes 310, 320, 340 and 345. It is appreciated that processing nodes and gateway nodes may be referred to generically as nodes throughout this application. In this exemplary embodiment, the processing nodes may represent various steps during a loan process, a process flow diagram for answering a call at a call center, directing Internet traffic flow, directing vehicle traffic flow, etc., as discussed with respect to FIGS. 1A-1C. Signals may be propagated downstream through the processing paths that connect the nodes. As noted above, certain nodes associated with different activities may take more time to process than other nodes associated with other activities. These processing delays may create bottlenecks or process hangs at some nodes and/or gateways. In other words, such bottlenecks and/or process hangs may arise at nodes and/or gateways that are expecting to receive more than one signal from more than one preceding node, e.g., processing node and/or gateway node. In order to avoid such bottlenecks and process hangs, a node may wait for a predetermined wait period to receive the signals and may proceed with processing if the signals are not received within a certain period of time (see FIGS. 2A-2C).

In an illustrative example, BPD 300 starts at processing node 305. Processing node 305 may transmit an activation signal 360a to gateway node 310 after processing node 305 completes its processing. In a similar manner, gateway node 310 may transmit an activation signal 360b to processing node 315 and an activation signal 360c to gateway node 320. In response to receiving the activation signals, processing node 315 and gateway node 320 initiate their respective processing. Once gateway node 320 completes its processing, activation signal 360d may be transmitted to processing node 330 and an activation signal 360e may be transmitted to processing node 335.

According to some embodiments, at each node, e.g., processing node or gateway node, a processor may determine whether to wait to receive a signal from its immediate preceding node to process parameters or to process parameters without waiting any further to receive a signal from its immediate preceding node. It is appreciated that a processor may determine whether to wait to receive a signal or to proceed with processing based on heuristics. The heuristics may be based on various factors, e.g., threshold time lapse, possibility of receiving a signal from the immediate preceding node, number of inputs at the current node, traversing upstream from the current node to preceding nodes, etc.

In this exemplary embodiment, prior to initiating the processing by processing nodes 330 and 335, it may be determined whether each of these respective processing nodes have any additional immediately preceding connections. For example, it is determined that processing node 330 is not connected to any other immediate preceding node, e.g., immediately preceding processing node and/or gateway node, and thus, processing at processing node 330 is initiated. It is appreciated that while processing node 330 has a preceding gateway node 310, gateway node 310 is not immediately connected thereto because gateway node 320 is connected therebetween. On the other hand, it is determined that processing node 335 is connected to processing node 315 and that no signal has been received from processing node 315. According to one embodiment, processing node 335 waits until a signal is received from processing node 315 in order to initiate its processing. In other words, processing node 335 has two immediately preceding nodes, a gateway node 320 which has sent a signal 360e to processing node 335 and a processing node 315, which has not sent a signal to processing node 335. It is appreciated that while processing node 305 and gateway node 310 are preceding nodes with respect to the processing node 335, they are not immediately preceding nodes with respect to the processing node 335 because they are connected to processing node 335 via other intermediary nodes, e.g., gateway node 320 and processing node 315.

It is appreciated that in one embodiment, processing node 315 may wait for a given period to receive a signal from processing node 335 (as discussed with respect FIGS. 2A-2C). If no signal is received within the wait period processing at processing node 335 is initiated. It is appreciated that the wait period may be user defined or it may be predetermined. Further, it is appreciated that the wait period associated with each node may be the same or different.

Once the processing node 335 completes its processing, a signal, e.g., activation signal 360f, may be transmitted to the proceeding node, e.g., processing nodes or gateway nodes such as gateway node 340. It is appreciated that other nodes in the process flow diagram process information in a similar fashion until the process and their respective execution is complete.

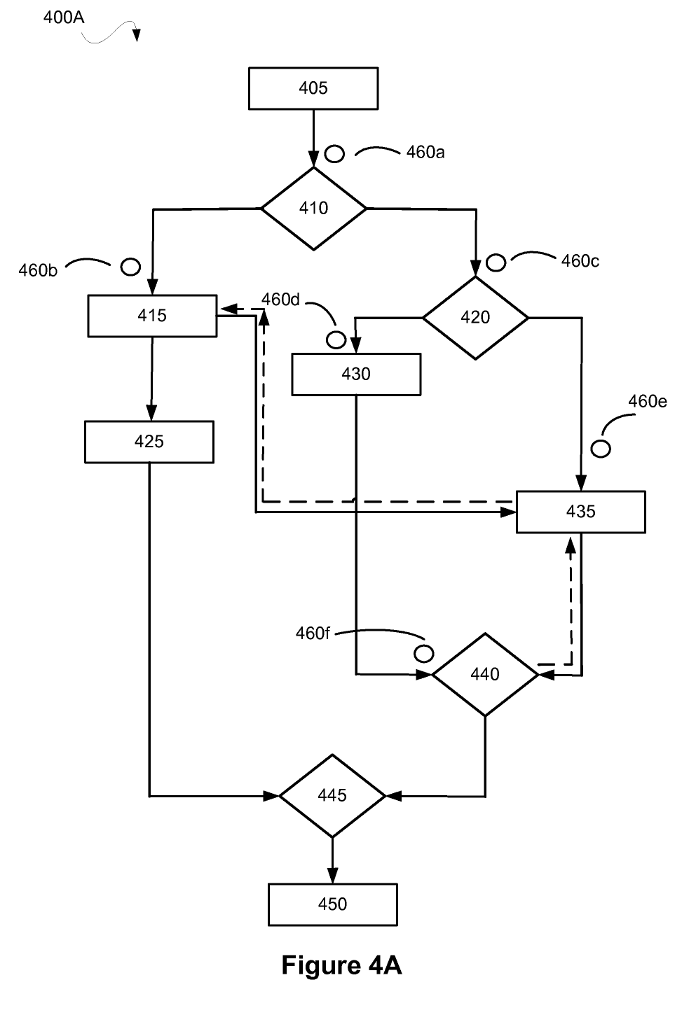

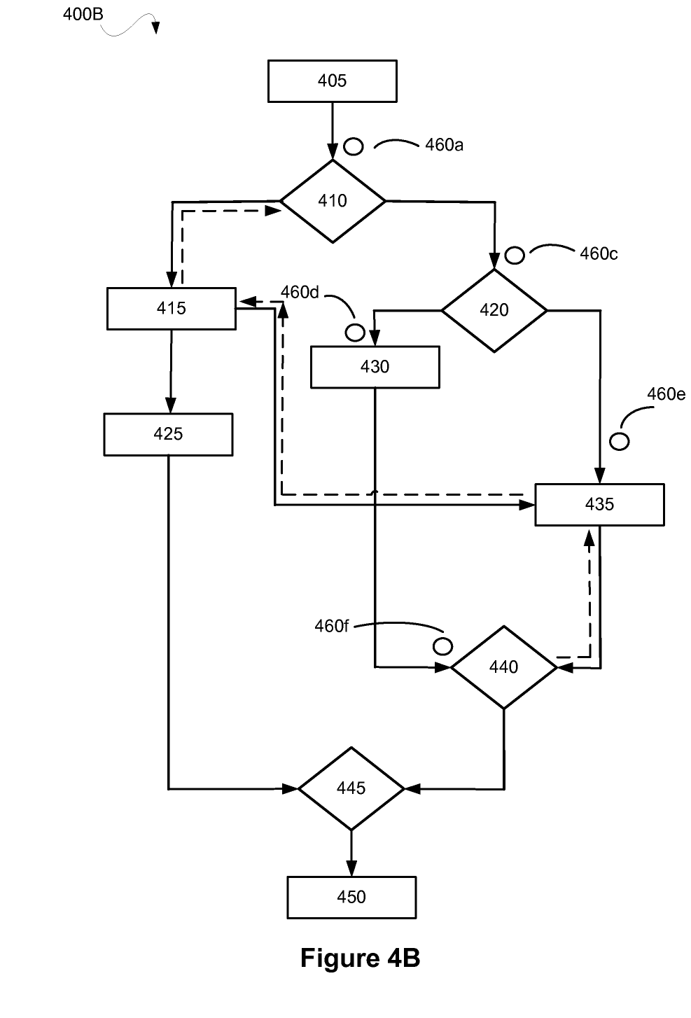

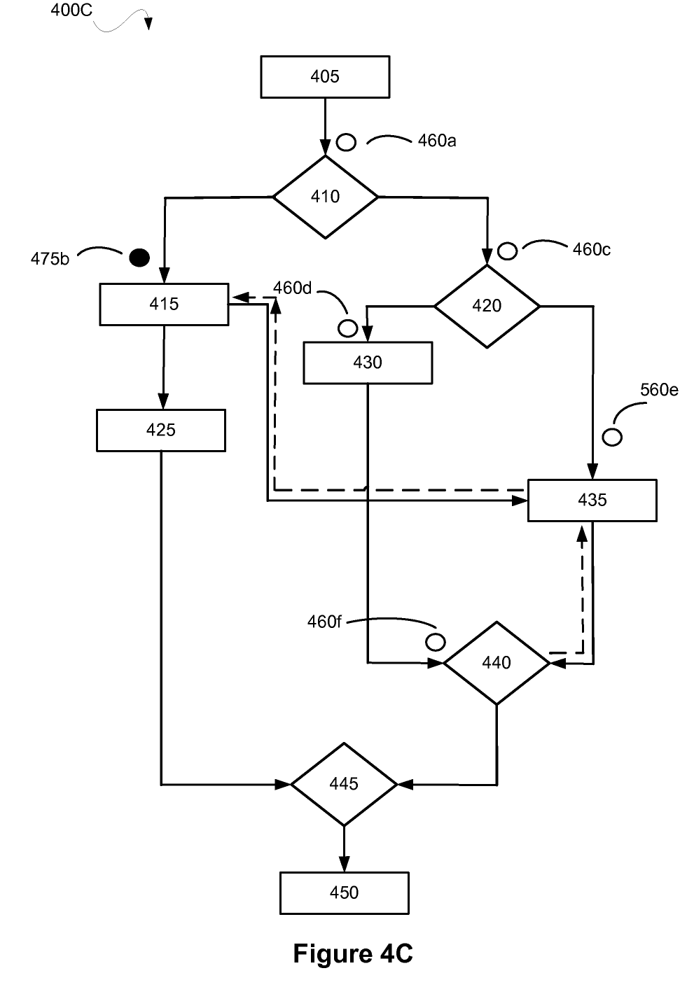

Referring now to FIGS. 4A-4C, execution of an exemplary unstructured process flow diagram is shown in accordance with some embodiments. In this exemplary embodiment, the processing nodes may represent various steps during a loan process, a process flow diagram for answering a call at a call center, directing Internet traffic flow, directing vehicle traffic flow, etc., as discussed with respect to FIGS. 1A-1C. According to some embodiments, at each node, e.g., processing node or gateway node, a processor may determine whether to wait to receive a signal from its immediate preceding node to process parameters or to process parameters without waiting any further to receive a signal from its immediate preceding node. It is appreciated that a processor may determine whether to wait to receive a signal or to proceed with processing based on heuristics. The heuristics may be based on various factors, e.g., threshold time lapse, possibility of receiving a signal from the immediate preceding node, number of inputs at the current node, traversing upstream from the current node to preceding nodes, etc.

In this exemplary embodiment, similar to FIGS. 1A-1C, a determination whether to wait for signal at a current node, e.g., current processing node or current gateway node, is based on a performing a reverse traversal. In an illustrative embodiment of FIG. 4A, each node, e.g., processing node and gateway node, processes its information and a generated signal, e.g., activation signal, deactivation signal, etc., is propagated throughout the process flow diagram. For example, processing nodes 405 and 430 and gateway nodes 410 and 420 process and generate activation signals 460a, 460b, 460c, 460d, 460e, and 460f. When processing node 435 receives the activation signal 460e, it may be determined whether processing node 435 is connected to another immediately preceding node, e.g., immediately preceding processing node and/or immediately preceding gateway node, that processing node 435 is waiting to receive a signal from. In this example, it is determined that processing node 435 is connected to immediately preceding processing node 415 and it has not received a signal from processing node 415. It is appreciated that processing node 415 and gateway node 420 are immediately preceding nodes with respect to processing node 435 because there are no other nodes connected therebetween. However, gateway 410 and processing node 405 are preceding nodes with respect to processing node 435 but are not immediately preceding nodes because there are other nodes connected therebetween, e.g., gateway node 420 and processing node 415. Accordingly, a reverse traversal is performed from processing node 435 to identify a live node associated with processing node 435. In this exemplary embodiment, processing node 415 is identified as the live node because it has received the activation signal 460b but it has not generated any signal itself. As described in FIGS. 1A-1C, once the processing node 415 is identified, it is determined whether there is a possibility that processing node 415 can generate an activation signal. In this exemplary embodiment, because processing node 415 receives the activation signal 460b, it is determined that processing node 415 may generate an activation signal, which may be propagated to processing node 435. Consequently, processing node 435 will wait to receive a signal from processing node 415 prior to initiating its own processing.

Similar to the processing node 435, when gateway node 440 receives the activation signal 460f from processing node 430, it is determined whether gateway node 440 is connected to any other immediately preceding node, e.g., immediately preceding processing node or gateway node, that is waiting to receive a signal from. In this example, it is determined that gateway node 440 is also connected to an immediate preceding processing node 435. As such, a reverse traversal may be performed from gateway node 440 to identify a live node associated with gateway node 440 in order to determine whether the gateway node 440 should wait to receive a signal or whether it should initiate its processing without receiving a signal from the live node. In a similar fashion as identification of live processing node 415 for processing node 435, processing node 435 may be identified as the live node for gateway node 440. It is appreciated that processing node 415 may be identified as a live node for gateway node 440 as well. In this example, since processing nodes 435 and 415 have both received activation signals 460e and 460b respectively, then it is determined that there is a possibility that each of those nodes will generate an activation signal. As such, gateway node 440 waits to receive a signal from processing node 435.

It is appreciated that the discussion in FIG. 4A of traversing a single node to identify a live node is exemplary and is not intended to limit the scope of the embodiments. It is appreciated that multiple nodes, e.g., processing nodes and/or gateway nodes, may be traversed upstream to identify a live node. Referring now to FIG. 4B, traversal through multiple nodes, e.g., processing nodes and gateway nodes, is shown to identify a live node. In this example, a reverse traversal upstream from processing node 435 to processing node 415 and subsequently to gateway node 410 is shown. In this example, gateway node 410 is identified as a live node. In this example, processing node 435 waits to receive a signal from processing node 415 because gateway node 410 has received activation signal 460a and may generate an activation signal to be propagated to through processing node 415 and subsequently through processing node 435. It is appreciated that traversal may be performed from gateway node 440 in a similar fashion. As such, in this example, gateway node 440 may wait to receive a signal from the processing node 435, which is waiting to receive a signal from processing node 415, which is waiting to receive a signal from gateway node 410.

In contrast, processing node 435 initiates its processing if gateway node 410 generated a deactivation signal 475b to node 415, as shown in FIG. 4C, by traversing from processing node 435 to the processing node 415. Traversal from processing node 435 to processing node 415 is used to determine that there is not a possibility of generating an activation signal by processing node 415 because processing node 415 has received the deactivation signal 475b. Traversal from gateway node 440 to processing node 435 identifies processing node 435 as the live node. As such, processing node 440 waits to receive a signal from processing node 435.

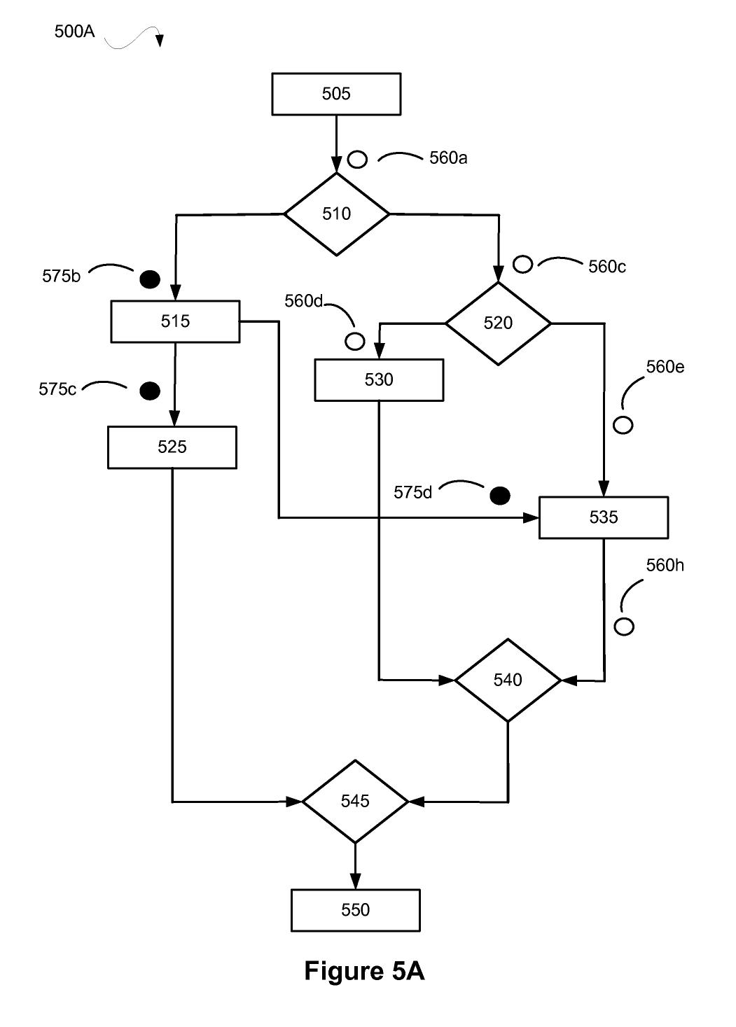

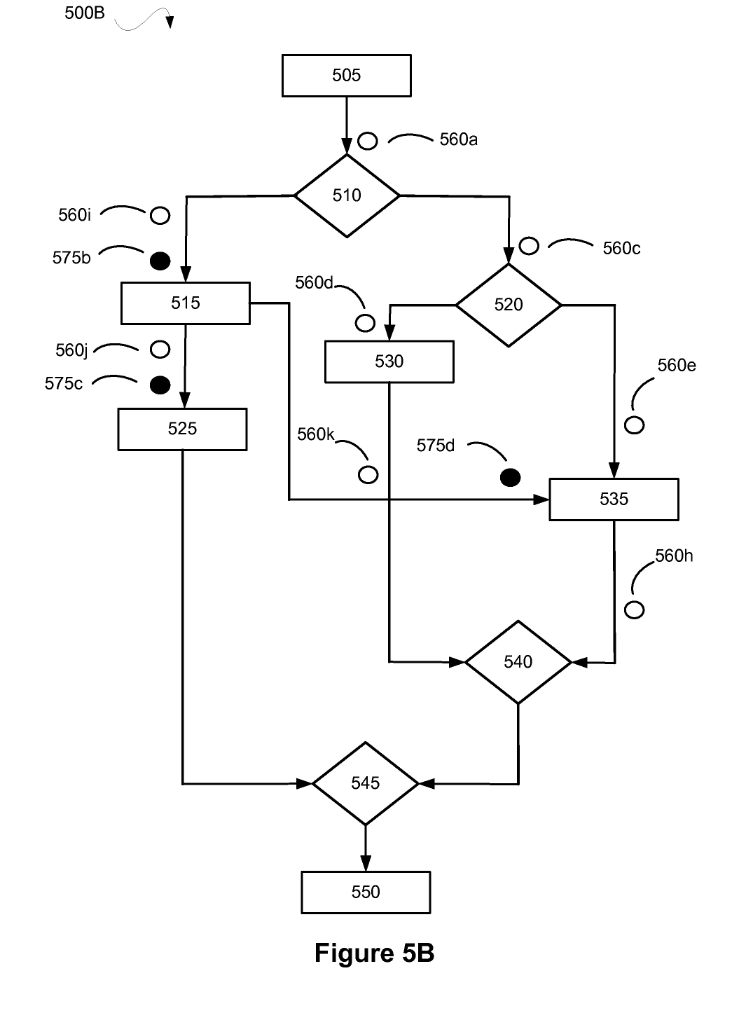

Referring now to FIGS. 5A-5B, execution of an exemplary process flow diagram being dynamically modified is shown in accordance with some embodiments. In this exemplary embodiment, FIG. 5A illustrates the execution state of BPD 500A at time T1 and FIG. 5B illustrates the execution state of BPD 500B at time T2.

Referring now to FIG. 5A, BPD 500A is substantially similar to the BPD illustrated in FIGS. 3 and 4A-4C. In some embodiments, it may be desired to re-execute some steps of a process flow diagram based on newly available information, parameters, and/or inputs that were not previously available. It is wasteful, time consuming, and process intensive if every node is re-executed based on the new information. In this exemplary embodiment, an activation signal may be injected at a desired node, e.g., processing node and/or gateway node, to cause the node and any subsequent nodes to re-execute without a need to re-execute preceding nodes.

In this exemplary embodiment, the processing nodes may represent various steps during a loan process, a process flow diagram for answering a call at a call center, directing Internet traffic flow, directing vehicle traffic flow, etc., as discussed with respect to FIGS. 1A-1C. According to some embodiments, at each node, e.g., processing node or gateway node, a processor may determine whether to wait to receive a signal from its immediate preceding node to process parameters or to process parameters without waiting any further to receive a signal from its immediate preceding node. Furthermore, the processor may further determine whether certain processing nodes and/or gateway nodes are to be re-executed based on new information. It is appreciated that the processor determination may be based on heuristics. The heuristics may be based on various factors, e.g., threshold time lapse, possibility of receiving a signal from the immediate preceding node, number of inputs at the current node, traversing upstream from the current node to preceding nodes, etc.

In an illustrative example with reference to FIG. 5A, BPD 500A starts at processing node 505 and transmits an activation signal 560a to gateway node 510. Upon completion of its processing, gateway node 510 transmits a deactivation signal 575b to processing node 515 and an activation signal 560c to gateway node 520. In this exemplary embodiment, the deactivation signal 575b may be transmitted to processing node 515 due to, for instance, a condition not being met and/or some parameters not being available. Deactivation signals 575c and 575d may be transmitted from processing node 515 to processing nodes 525 and 535, respectively. In the meantime, gateway node 520 processes parameters and executes processes associated with gateway node 520 in response to receiving activation signal 560c. Activation signals 560d and 560e are transmitted from gateway node 520 to processing nodes 530 and 535, respectively.

Processing at processing node 535 is initiated because processing node 535 has received signals, activation signal 560e and deactivation signal 575d, from all of its immediately preceding nodes, e.g., processing nodes and/or gateway nodes. As presented above, gateway node 520 and processing node 515 are immediately preceding nodes for processing node 535 while gateway node 510 and processing node 505 are merely preceding nodes and not immediately preceding nodes for processing node 535. A signal, e.g., activation signal 560h, may be generated and transmitted from processing node 535 to gateway node 540.

After processing node 535 completes its processing, an activation signal 560i may be injected at processing node 515, as illustrated in FIG. 5B. It is appreciated that the injection of an activation signal may be a user input, a user alteration of the process flow, a computer triggered signal injection, etc. Processing node 515 is upstream and precedes processing node 535, thus possibly impacting the outcome of processing node 535. In some instances, an activation signal, such as activation signal 560i, may be injected because information that was previously unavailable may become available during the course of executing BPD 500B, e.g., credit score may have been unavailable during the loan approval process and may become available later, an appraisal may not have been available during the loan approval process, etc., and thus, it may be desired to re-execute certain processing steps.

In this example, the injection of activation signal 560i causes processing node 515 to re-process. As such, processing node 515 may transmit updated signals, e.g., activation signals 560j and 560k, to processing nodes 525 and 535, respectively. In response to receiving the updated signals, processing nodes 525 and 535 determine whether any additional incoming signals are expected from immediately preceding nodes, e.g., immediately preceding processing nodes and/or immediately preceding gateway nodes. Processing by nodes based on the updated information may be performed in a similar fashion, as described with respect to FIGS. 3 and 4A-4C.

It is appreciated that by allowing an injection signal at a node, e.g., at a processing node and/or a gateway node, the sequence of steps may be dynamically changed without requiring a user or a system to redesign the process flow diagram and without a need to re-execute every gateway node and processing node.

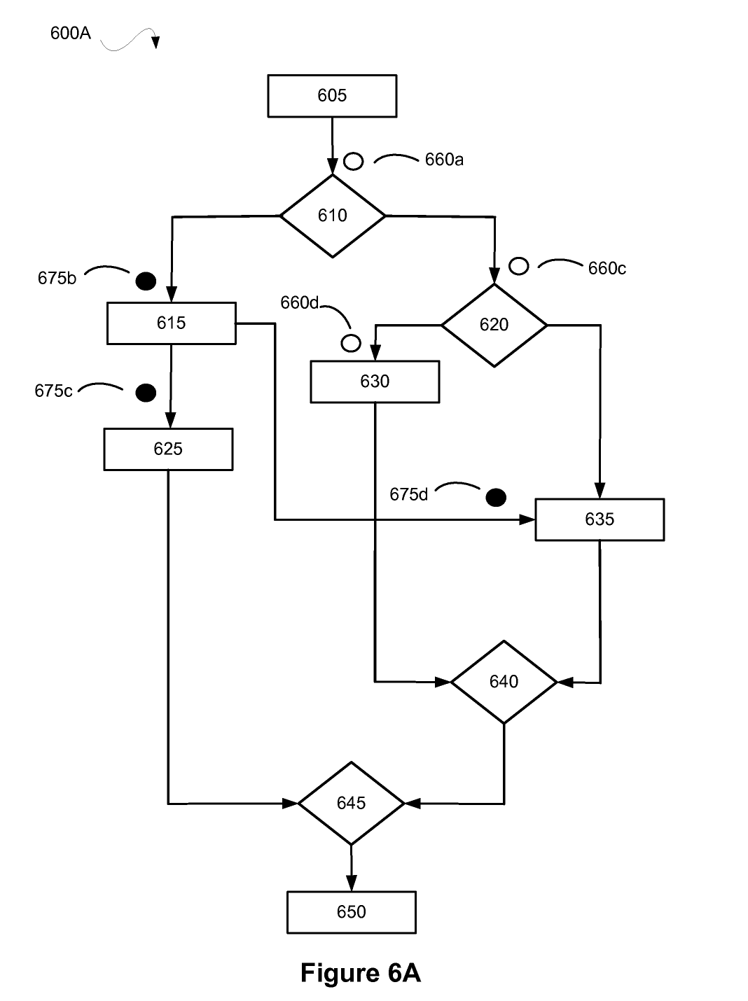

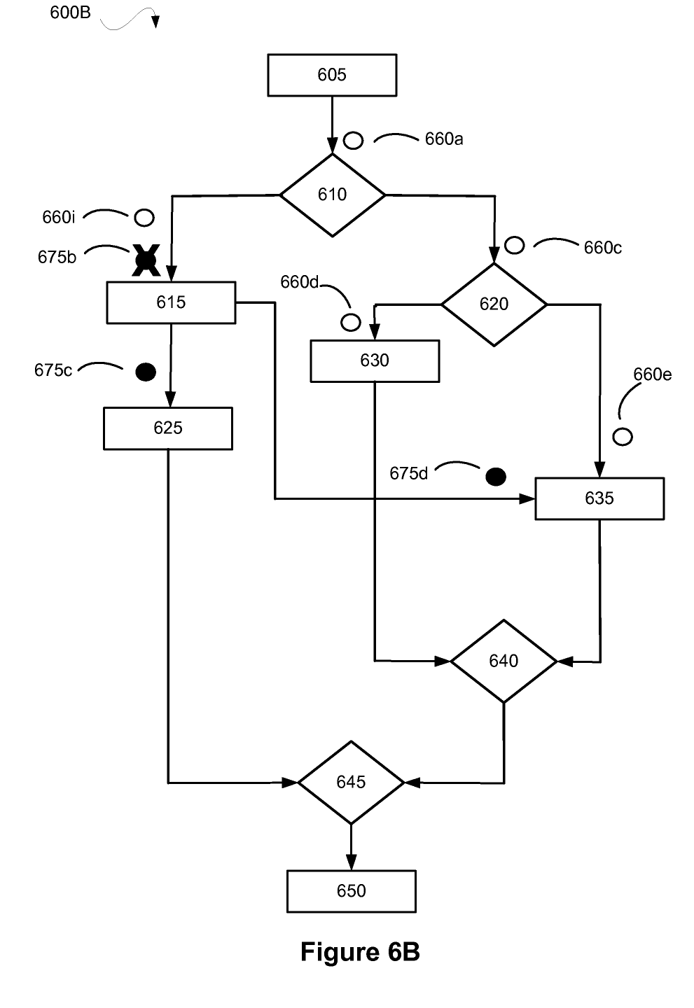

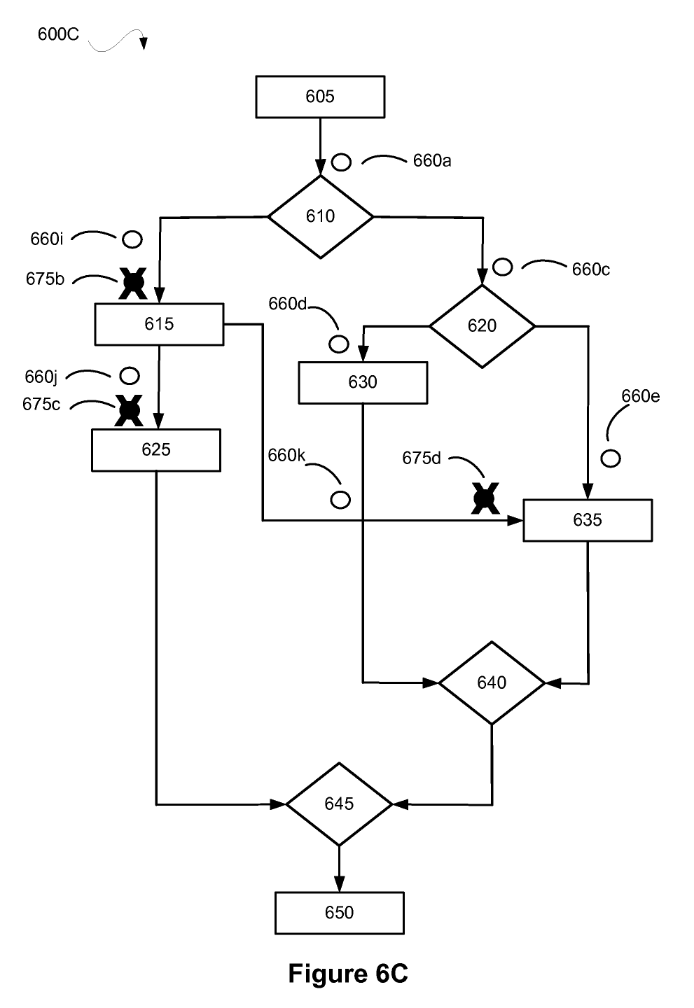

Referring now to FIGS. 6A-6C, an execution of an exemplary process flow diagram being dynamically modified is shown in accordance with some embodiments. Process flow diagram 600A is substantially similar to that of BPD 500A and BPD 500B, except that some nodes succeeding a node being injected with an activation signal wait to receive updated signals prior to processing parameters.

Signals are transmitted and propagated to the nodes, e.g., processing nodes and gateway nodes, in a similar fashion described with respect to FIGS. 5A and 5B. In this example, processing node 635 receives a deactivation signal 675d from processing node 615. However, processing node 635 has not received any signal from gateway node 620. In one embodiment, as presented above, reverse traversal is performed from processing node 635 to identify a live node, e.g., live processing node or a live gateway node such as gateway node 620. Since the live gateway node 620 has received activation signal 660c, it is possible for gateway node 620 to generate an activation signal for processing node 635. As such, processing node 635 may wait until a signal is generated by gateway node 620. In another embodiment, as presented above, processing node 635 may wait to receive a signal from gateway node 620 upon determining that it ought to receive two inputs, one from gateway node 620 and one from processing node 615. In a further embodiment, processing node 635 may merely wait for a certain wait period and if no signal is received it proceeds with its processing.

Referring now to FIG. 6B, processing node 635 receives activation signal 660e from gateway node 620. In this embodiment, a final determination may be made to determine whether it is possible for processing node 635 to receive an activation signal from processing node 615 to replace the already received deactivation signal 675d. In this exemplary embodiment, the determination is made by performing a reverse traversal to identify a live node. Here, reverse traversal upstream, identifies processing node 615 as a live node because processing node 615 was injected with an activation signal 660i at some time prior to processing node 635 receiving the activation signal 660e. Processing node 635 waits because there is a possibility that processing node 615 may generate an activation signal for transmission to processing node 635, replacing the deactivation signal 675d. As a result, processing node 635 waits to receive an updated signal from processing node 615 before processing parameters. In some embodiments, processing node 635 may wait to receive an updated signal for a specific wait period.

Referring now to FIG. 6C, activation signal 660i is injected to processing node 615 causing processing node 615 to generate activation signals 660j and 660k for transmission to processing nodes 625 and 635, respectively, in order to replace the previous signals 675c and 675d respectively. When processing node 635 receives the updated signal, e.g., activation signal 660k, processing node 635 initiates its processing based on the updated information. Once processing node 635 completes its processing, a signal (not shown) is transmitted to the next node in the BPD (e.g., gateway 640). Every node may be processed in a similar fashion.

Although FIGS. 5A-5B and 6A-6C discuss injecting an activation signal at processing nodes 515 and 615, respectively, it is appreciated that it is exemplary and is not intended to limit the scope of the embodiments. For example, an activation signal may be injected at any node, e.g., processing node 635, thereby causing re-execution of processing node 635 and succeeding gateway nodes 640 and 645 and processing node 650. It is further appreciated that in some instances a deactivation signal may injected instead of an activation signal in order to skip and/or deactivate the execution of certain nodes, e.g., processing nodes or gateway nodes.

It is further appreciated that a signal may be injected in a process flow diagram by a user via a graphical user interface displaying the flow diagram, and/or may be dynamically injected by a computer system executing the process flow diagram. It is further appreciated that by allowing injection of a signal during runtime, the sequence and execution of nodes may be dynamically changed. It is further appreciated that injecting a signal in an unstructured BPD as illustrated in FIGS. 5A-5B and 6A-6C are exemplary, and are not intended to limit the scope of the embodiments. In some embodiments, a signal may be injected in a structured process flow diagram.

It also appreciated that the BPD illustrated in FIGS. 1A-1C, 2A-2C, 3, 4A-4C, 5A-5B and 6A-6B are exemplary and are not intended to limit the scope of the embodiments. Various types of BPD may be designed to express a specific type of process or business method. It is further appreciated that the embodiments described herein may be implemented using modeling languages, such as Business Process Model and Notation (BPMN), Business Process Execution Language (BPEL), Extensible Markup Language (XML) Process Definition Language (XPDL), etc.

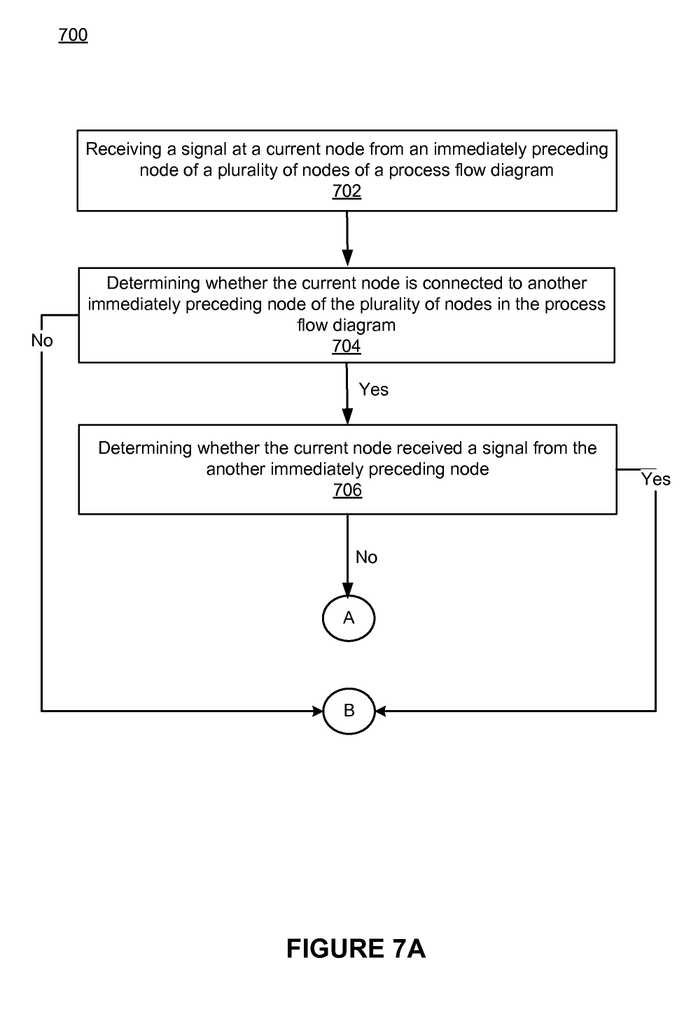

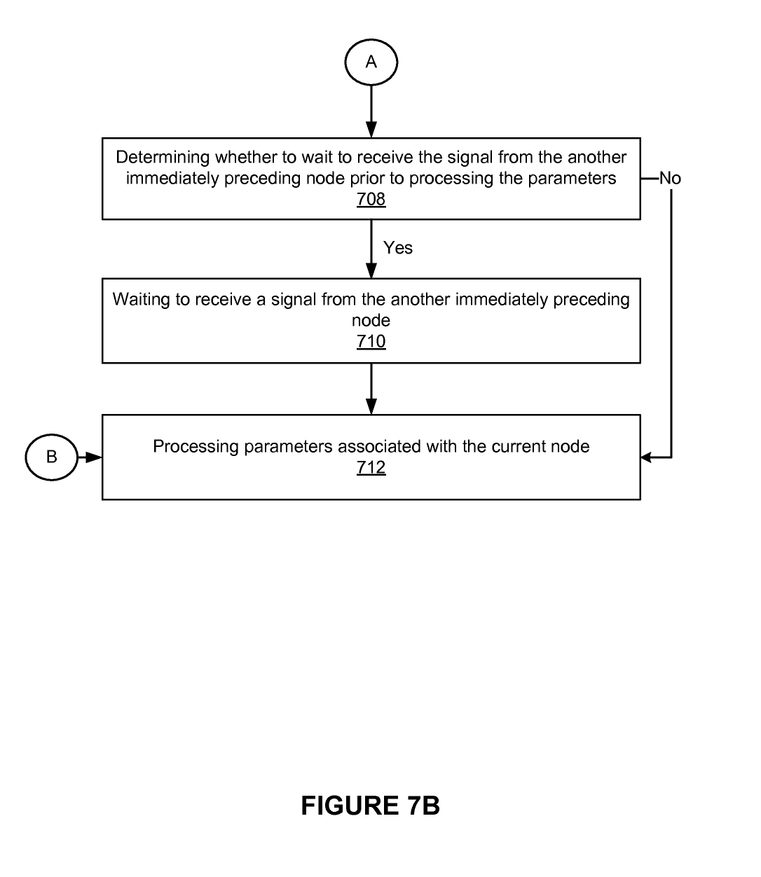

Referring now to FIGS. 7A-7B, an exemplary method to execute a process flow diagram is shown in accordance with an embodiment. In some embodiments, servers and/or computing devices may be configured to implement all or parts of method 700.

At step 702, receiving a signal at a current node from an immediately preceding node of a plurality of nodes of a process flow diagram. In some embodiments, the process flow diagram may be a business process diagram (BPD). In some embodiments, the current node may be a processing node and/or a gateway node associated with an activity, event, and/or some other flow process diagram modeling language construct. In some embodiments, parameters associated with the current node may be executed by a server and/or a computing device executing the process flow diagram.

In some embodiments, the signal received by the current node may be a deactivation signal and/or an activation signal as described herein. It is appreciated that a signal, e.g., activation signal, deactivation signal, etc., may be a token, a message, a command, an indication, etc. In some embodiments, the signal is received at the current node after the immediately preceding node completes processing parameters associated with the immediately preceding node.

At step 704, in response to receiving the signal from the immediately preceding node, it is determined whether the current node is connected to another immediately preceding node. In some embodiments, this determination may be made by sending a signal and/or a query from the current node to other nodes in the BPD. In some embodiments, this determination may be made by accounting for the number of incoming processing paths to the current node. In some embodiments, the current node may execute a program specific command to determine whether any other nodes are connected to the current node. If it is determined that the current node is not connected to another immediately preceding node, then method 700 proceeds to step 712 (shown in FIG. 7B) to process parameters associated with the current node. Otherwise, method 700 proceeds to step 706 (shown in FIG. 7A).

At 706, it is determined whether the current node received a signal, e.g., an activation signal, deactivation signal, etc., from the immediately preceding node identified in step 706. If a signal is received, then method 700 proceeds to step 712 (FIG. 7B). Otherwise, method 700 proceeds to step 708 (FIG. 7B).

At step 708, it is determined whether to wait to receive a signal from the immediately preceding node identified at step 706 prior to processing the parameters. In some embodiments, a reverse traversal from the current node may be performed as described herein to identify a live node. It is determined whether the live node can possibly generate an activation signal. If the identified live node can generate an activation signal, then the current node waits to receive a signal from the immediately preceding node identified in step 706 (step 710 shown in FIG. 7B). Once the current node receives the signal, either an activation or deactivation signal, from the identified preceding node, then method 700 proceeds to step 712 to process parameters associated with the current node. On the other hand, if it is determined that the live node cannot generate an activation signal for the current node, then the method 700 proceeds to step 712 to process parameters associated with the current node in the absence of receiving a signal from the immediately preceding node identified in step 706.

In some embodiments, rather than performing a reverse traversal, the current node may wait to receive a signal from the immediately preceding node identified in step 706 for a period of time as described above in FIGS. 2A-2C and FIG. 3. If the current node receives the signal within the wait period, then the current node processes parameters associated with the current node (step 714) once the signal is received. Otherwise, the current node processes parameters without receiving a signal after the wait period is expired. It is appreciated that the wait period may be user defined, system defined, and/or may or may not be some predetermined wait period.

In some embodiments, the determination whether to wait (step 710) and waiting to receive a signal may include a combination of performing a reverse traversal as described herein and waiting for a signal for a given wait period. It is appreciated that in some embodiments, the current node may wait to receive a signal from the immediately preceding node if it is determined that no signal has been received from the incoming processing path to the current node.

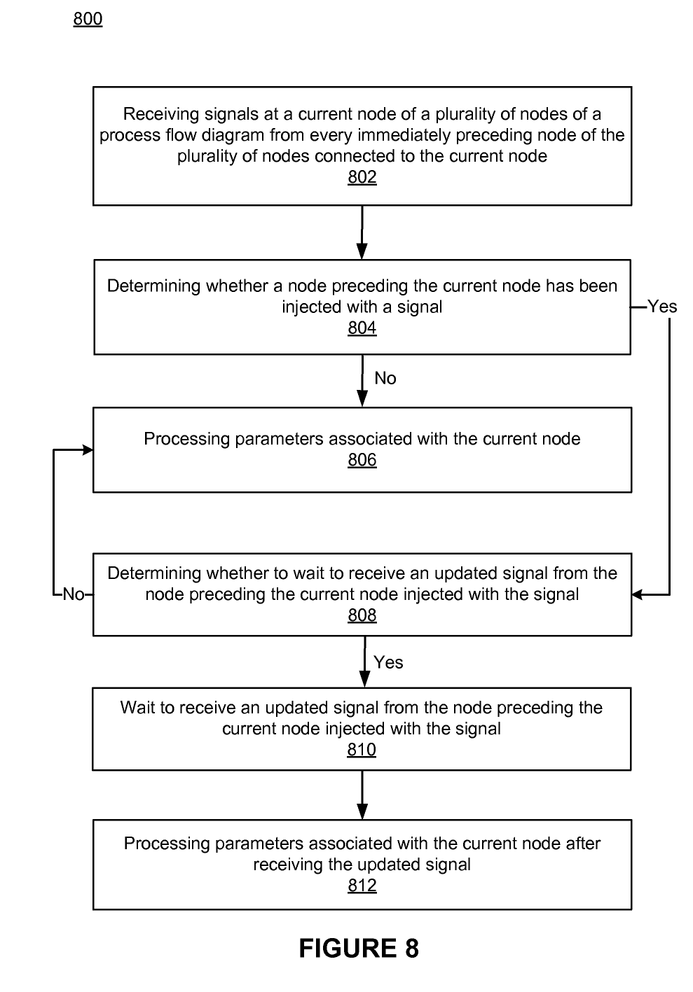

Referring now to FIG. 8, an exemplary method to execute a process flow diagram being dynamically modified is shown in accordance with an embodiment. In some embodiments, servers and/or computing devices may be configured to implement all or parts of method 800.

At step 802, a current node of a process flow diagram may receive signals, e.g., activation signal, deactivation signal, from every immediately preceding node. In some embodiments, the process flow diagram may be a BPD as described herein. In some embodiments, the current node of the process flow diagram may receive signals in a similar fashion as nodes 535 and 635 of FIGS. 5A-5B and FIGS. 6A-6C, respectively. In some embodiments, the process flow diagram may be an unstructured or structured process flow diagram as described herein.

At step 804, it is determined whether a node preceding the current node has been injected with a signal that can modify the behavior of the system, e.g., a deactivation signal changed to an activation signal, an activation signal changed to a deactivation signal, etc. In some embodiments, this determination is made by performing a reverse traversal as described herein from the current node to nodes preceding nodes to identify a node injected with a signal. In some embodiments, this determination is made in a similar fashion as described in FIGS. 5A-5B and FIGS. 6A-6C. In some embodiments, if the current node receives at least one deactivation signal, the determination at step 804 may be performed to determine whether it is possible to replace the deactivation signal with an activation signal.

If it is determined at step 804 that a node preceding the current node has not been injected with a signal, then method 800 proceeds to step 806 to process parameters associated with the current node. Otherwise, method 800 proceeds to step 808 to determine whether to wait to receive an updated signal from the node preceding the current node being injected with the signal. If the node preceding the current node is injected with a deactivation signal, then it is determined not to wait to receive an updated signal at the current node. As noted above, the deactivation signal may indicate that a processing step is supposed to be skipped in a process flow diagram, may indicate the unavailability of parameters and/or inputs for processing, etc. In this exemplary embodiment, method 800 proceeds back to step 806 to process parameters associated with the current node without waiting to receive an updated signal from the node preceding the current node injected with the signal.

In some embodiments, if the node preceding the current node is injected with an activation signal, then method 800 proceeds to step 808 to wait to receive an updated signal from the node preceding the current node that is injected with the activation signal. In some embodiments, the current node waits indefinitely until an updated signal is received. In some embodiments, the current node waits for a given wait period.

Once the current node receives the updated signal, method 800 proceeds to step 810 to process parameters associated with the current node with the updated information. In some embodiments, the current node may process the current node with the updated information in a similar fashion as nodes 535 and nodes 635 of FIGS. 5A-5B and FIGS. 6A-6C, respectively.

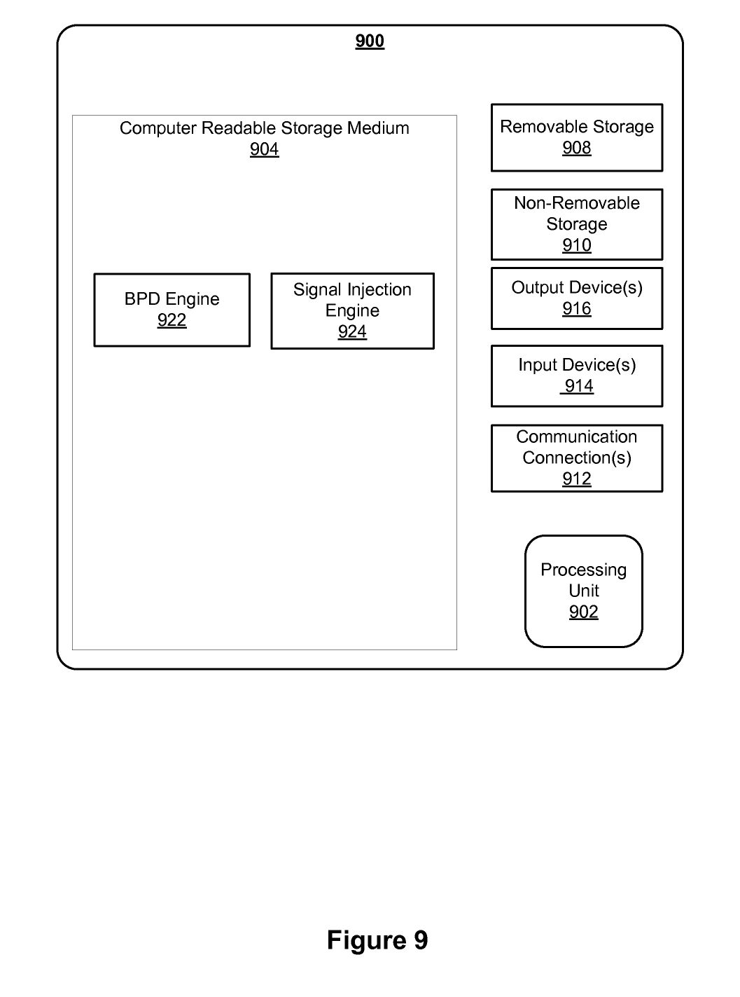

Referring now to FIG. 9, a block diagram of an exemplary computer system is shown in accordance with one embodiment. With reference to FIG. 9, an exemplary system module for implementing embodiments disclosed herein, such as the embodiments described in FIGS. 1A-1C, 2A-2C, 3, 4A-4C, 5A-5B, and 6A-6C. In some embodiments, the system includes a general purpose computing system environment, such as computing system environment 900. Computing system environment 900 may include, but is not limited to, servers, desktop computers, laptops, tablets, mobile devices, and smartphones. In its most basic configuration, computing system environment 900 typically includes at least one processing unit 902 and computer readable storage medium 904. Depending on the exact configuration and type of computing system environment, computer readable storage medium 904 may be volatile (such as RAM), non-volatile (such as ROM, flash memory, etc.) or some combination of the two. Portions of computer readable storage medium 904 when executed facilitates the configuring of devices according to embodiments described herein, e.g., processes 700 and 800.

Additionally in various embodiments, computing system environment 900 may also have other features/functionality. For example, computing system environment 900 may also include additional storage (removable and/or non-removable) including, but not limited to, magnetic or optical disks or tape. Such additional storage is illustrated by removable storage 908 and non-removable storage 910. Computer storage media includes volatile and nonvolatile, removable and non-removable media implemented in any method or technology for storage of information such as computer readable instructions, data structures, program modules or other data. Computer readable medium 904, removable storage 908 and nonremovable storage 910 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 900. Any such computer storage media may be part of computing system environment 900.

In some embodiments, computing system environment 900 may also contain communications connection(s) 912 that allow it to communicate with other devices. Communications connection(s) 912 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 912 may allow computing system environment 900 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 912 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 900 may also have input device(s) 914 such as keyboard, mouse, a terminal or terminal emulator (either directly connected or remotely accessible via telnet, SSH, http, SSL, etc.), pen, voice input device, touch input device, remote control, etc. Output device(s) 916 such as a display, a terminal or terminal emulator (either directly connected or remotely accessible via telnet, SSH, http, SSL, etc.), speakers, LEDs, etc. may also be included.

In one embodiment, computer readable storage medium 904 includes a BPD engine 922 and a signal injection engine 924. The BPD engine 922 is operable to execute a BPD as described in FIGS. 1A-1C, 2A-2C, 3, 4A-4C, 5A-5B, and 6A-6C. For example, the BPD engine 922 is configured to determine, prior to processing parameters at a node, whether to wait at the node to receive a signal from a preceding node by waiting for a predetermined wait period, performing reverse traversal as described herein, determining the number of inputs of a node, and/or some combination thereof. The signal injection engine 924 may be configured to inject and re-execute nodes and succeeding nodes dependent on the node injected with a signal as described in FIGS. 5A-5B and 6A-6C.

It is appreciated that implementations according to embodiments that are described with respect to a computer system are merely exemplary and not intended to limit the scope of the embodiments. For example, embodiments may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams of FIGS. 7A-7B and FIG. 8.

The foregoing description, for purposes of explanation, has been described with reference to specific embodiments. However, the illustrative discussion above is not intended to be exhaustive or limit the invention to the precise forms disclosed. Many modifications and variations are possible in view of the above teachings.

What is claimed is:

1. A method comprising:
processing parameters, within a processor, at a current node of a plurality of nodes in a process flow diagram;
receiving a signal at the current node from a first immediate preceding node of the plurality of nodes, wherein the first immediate preceding node is connected to the current node;
determining whether the current node is connected to a second immediate preceding node of the plurality of nodes in the process flow diagram; and
in response to determining that the current node is connected to the second immediate preceding node, determining whether to process parameters associated with the current node in absence of receipt of a signal from the second immediate preceding node or to wait to receive the signal from the second immediate preceding node prior to processing the parameters, wherein the determining whether to process the parameters at the current node or whether to wait is based on heuristics.

2. The method of claim 1, wherein:
the process flow diagram is unstructured; and
the unstructured process flow diagram includes a dependency between two branches within the process flow diagram.

3. The method of claim 1 further comprising:
receiving the signal from the second immediate preceding node within a predetermined wait time period;
responsive to receiving the signal from the second immediate preceding node, processing the parameters associated with the current node; and
transmitting a signal from the current node to an immediate succeeding node of the plurality of nodes, wherein the transmitted signal from the current node is an activation signal or a deactivation signal.

4. The method of claim 1 further comprising:
processing the parameters associated with the current node in response to a wait time exceeding a wait time period and further in absence of receiving the signal from the second immediate preceding node; and
transmitting a signal from the current node to an immediate succeeding node of the plurality of nodes, wherein the transmitted signal from the current node is an activation signal or a deactivation signal.

5. The method of claim 1 further comprising:
in response to determining that the current node is connected to the second immediate preceding node and further in response to absence of receipt of the signal from the second immediate preceding node, traversing from the current node to the second immediate preceding node and further to nodes preceding the second immediate preceding node and connected thereto to identify a live node.

6. The method of claim 5 further comprising:
waiting to receive a signal at the current node from the identified live node in response to determining that the identified live node is operable to generate an activation signal for the current node.

7. The method of claim 5 further comprising:
responsive to determining that the identified live node is inoperable to generate an activation signal for the current node, processing the parameters associated with the current node in absence of receiving the signal from the second immediate preceding node.

8. The method of claim 1 further comprising:
receiving an activation signal being injected at a node preceding the current node, wherein the node preceding the current node being injected with the activation signal previously generated a deactivation signal; and
re-processing parameters associated with the node preceding the current node being injected with the activation signal.

9. The method of claim 8 further comprising:
processing parameters associated with the current node prior to the activation signal being injected to the node preceding the current node;
transmitting a signal from the current node to an immediate succeeding node of the plurality of nodes, wherein the transmitted signal from the current node is an activation signal or a deactivation signal; and
re-processing the parameters associated with the current node in response to the injection of the activation signal to the node preceding the current node and further in response to the re-processing generating an activation signal.

10. The method of claim 8 further comprising:
receiving signals at the current node from every immediate preceding node of the plurality of nodes connected to the current node;
in response to the activation signal being injected, waiting at the current node to receive an updated signal from the node preceding the current node being injected with the activation signal and further waiting at the current node to receive updated signals from nodes that connect the node being injected and the current node; and
processing parameters associated with the current node in response to receiving the updated signals.

11. A non-transitory computer-readable storage medium having stored thereon, computer executable instructions that, if executed by a processor causes the processor to perform a method comprising:
executing processes associated with a current node of a plurality of nodes of a process flow diagram;
receiving an activation signal being injected at a node preceding the current node, wherein the node preceding the current node being injected with the activation signal previously generated a deactivation signal; and
responsive to receiving the activation signal being injected, executing processes associated with the node preceding the current node.

12. The non-transitory computer readable medium of claim 11, wherein the method further comprises:
re-executing processes associated with the current node in response to the injection of the activation signal to the node preceding the current node and further in response to receiving an updated signal from nodes that connected the node being injected and the current node.

13. The non-transitory computer readable medium of claim 11, wherein the method further comprises:
before the activation signal being injected, receiving signals at the current node from every immediate preceding node of the plurality of nodes connected to the current node;
in response to receiving signals at the current node from every immediate preceding node, traversing from the current node to nodes preceding the particular node to identify whether a node preceding the current node has been injected with the activation signal; and
in response to determining that the node preceding the current node has been injected with the activation signal, determining whether to wait for updated signals to be received by the current node.

14. The non-transitory computer readable medium of claim 13, wherein the method further comprises:
in response to determining to wait for updated signals to be received by the current node and in response to receiving the updated signals, re-processing at the current node based on the updated signals.

15. The non-transitory computer readable medium of claim 13, wherein the method further comprises waiting for the updated signals for a predetermined wait period.

16. A method comprising:
receiving a signal at a current node of a plurality of nodes of a process flow diagram from a first immediate preceding node, wherein the signal is an activation signal or a deactivation signal;
in response to receiving the signal, determining, using a processor, whether the current node is connected to a second immediate preceding node of the plurality of nodes;
in response to determining that the current node is connected to the second immediate preceding node and in absence of receipt of a signal from the second immediate node, traversing, using the processor, from the current node to the second immediate preceding node and further to nodes preceding the second immediate preceding node connected thereto to identify a live node; and
determining whether the live node is operable to generate an activation signal for the current node.

17. The method of claim 17 further comprising:
waiting to receive a signal at the current node from the identified live node in response to determining that the identified live node is operable to generate an activation signal for the current node.

18. The method of claim 17 further comprising:
responsive to determining that the live node is inoperable to generate an activation signal for the current node, executing processes associated with the current node in absence of receiving the signal from the second immediate preceding node.

19. The method of claim 17 further comprising:
receiving an activation signal being injected at a node preceding the current node, wherein the node preceding the current node being injected with the activation signal previously generated a deactivation signal; and
responsive to receiving the activation signal, executing processes associated with the node preceding the current node being injected with the activation signal.

20. The method of claim 19, further comprising:
receiving signals at the current node from every immediate preceding node of the plurality of nodes connected to the current node;
in response to the activation signal being injected, waiting at the current node to receive an updated signal from the node preceding the current node being injected with the activation signal and further waiting at the current node to receive updated signals from nodes that connect the node being injected and the current node; and
executing processes associated with the current node in response to receiving the updated signals.
